(19) United States
(12) Patent Application Publication
(10) Pub. No.: US 2012/0066590 A1
(43) Pub. Date: Mar. 15, 2012

(54) Systems and Methods for Enhanced Font Management

(76) Inventors: Jeffrey Harris, New York, NY (US); David Joseph Kuettel, San Jose, CA (US); Jeremie Lenfant-Engelmann, San Francisco, CA (US); Carl Tancred Johannes Lindholm, Helsinki (FI); Luiz Amaral Franca Pereira Filho, New York, NY (US)

(21) Appl. No.: 13/117,386

(22) Filed: May 27, 2011

Related U.S. Application Data
(60) Provisional application No. 61/381,665, filed on Sep. 10, 2010.

(51) Int. Cl. G06F 17/21

(52) U.S. Cl. 715/269

(57) ABSTRACT

A first request that the user device render a first text in a default font is transmitted to a user device, and a second request that the user device render a second text in the desired font is transmitted to the user device. Data pertaining to the desired font is provided to the user device, if a first dimension of the first text is the same as a second dimension of the second text. For example, the data may comprise a request that the user device download the desired font from a specified source. The first dimension may be a width of the first text and the second dimension may be a width of the second text, for example.

This application claims the benefit of provisional patent application Ser. No. 61/381,665, filed Sep. 10, 2010, which is hereby incorporated by reference.

### FIELD OF THE INVENTION

This invention relates generally to systems and methods for providing online services, and more particularly to systems and methods for providing online word processing services.

### BACKGROUND

Online word processing applications are used to enable users to create and edit documents via a network. In an online word processing system, documents created by a user are stored at a location remote from the user's device. Many online word processing applications also enable multiple users to share documents by allowing multiple user devices to access a document simultaneously. Many online word processing applications enable users to edit documents using common features such as text searching, redlining, etc., and to format documents using various styles, fonts, etc.

When a user of an online word processing application requests use of a font that is offered by the online word processing application but is not stored locally on the user's device, the requested font may need to be downloaded by the user's device, causing delays which can detract from the user's online experience.

### SUMMARY OF THE INVENTION

In accordance with an embodiment of the invention, a method for providing online services is provided. A first request that the user device render a first text in a default font is transmitted to a user device, and a second request that the user device render a second text in the desired font is transmitted to the user device. Data pertaining to the desired font is provided to the user device, if a first dimension of the first text is the same as a second dimension of the second text. For example, the data may comprise a request that the user device download the desired font from a specified source. The first dimension may be a width of the first text and the second dimension may be a width of the second text, for example.

In one embodiment, a request that the user device display a portion of a document is transmitted, and one or more requests that the user device render the first text and the second text in a region that is not displayed are transmitted. A request that the user device display at least a portion of the document using the desired font may also be transmitted. The first text and the second text may comprise identical strings of alphanumeric characters. The online word processor may be accessible via a network.

In another embodiment, a request that the user device display a message indicating that the desired font is being downloaded is transmitted, during the downloading step. A selection of an option to download the desired font may be received from the user device.

In another embodiment of the invention, a method for providing online services is provided. A request to access a document from a user device is received, and one or more fonts used in the document are identified. A missing font that is not stored on the user device is determined from among the identified fonts, and data pertaining to the missing font is provided to the user device. A first request that the user device display a message indicating that the missing font is being downloaded is transmitted, and a second request that the user device display the document using the at least one font is transmitted.

In one embodiment, the data pertaining to the missing font is transmitted to a second user device, and a request that the second user device display a second message indicating that the missing font is being downloaded is transmitted.

In another embodiment, a method for providing online services is provided. One or more fonts used in a document that is shared by a plurality of user devices are identified. A missing font that is not stored on a selected one of the user devices is determined from among the identified fonts, and data pertaining to the missing font is provided to the selected user device and to at least one other user device in the plurality of user devices.

These and other advantages of the present disclosure will be apparent to those of ordinary skill in the art by reference to the following Detailed Description and the accompanying drawings.

### BRIEF DESCRIPTION OF THE DRAWINGS

FIG. 1 shows a communication system that may be used to provide online services, in accordance with an embodiment of the invention;

FIG. 2 shows functional components of a user device, in accordance with the embodiment of FIG. 1;

FIG. 3 shows a document displayed on a Web page, in accordance with an embodiment of the invention;

FIG. 4 is a flowchart of a method for providing font management services, in accordance with an embodiment of the invention;

FIG. 5 shows a Web page with a font download option, in accordance with an embodiment of the invention;

FIG. 6 is a flowchart of a method for providing a font to a user device, in accordance with an embodiment of the invention;

FIG. 7 shows a Web page displaying a downloading font message, in accordance with an embodiment of the invention; and

FIG. 8 shows components of a computer, in accordance with an embodiment of the invention.

### DETAILED DESCRIPTION

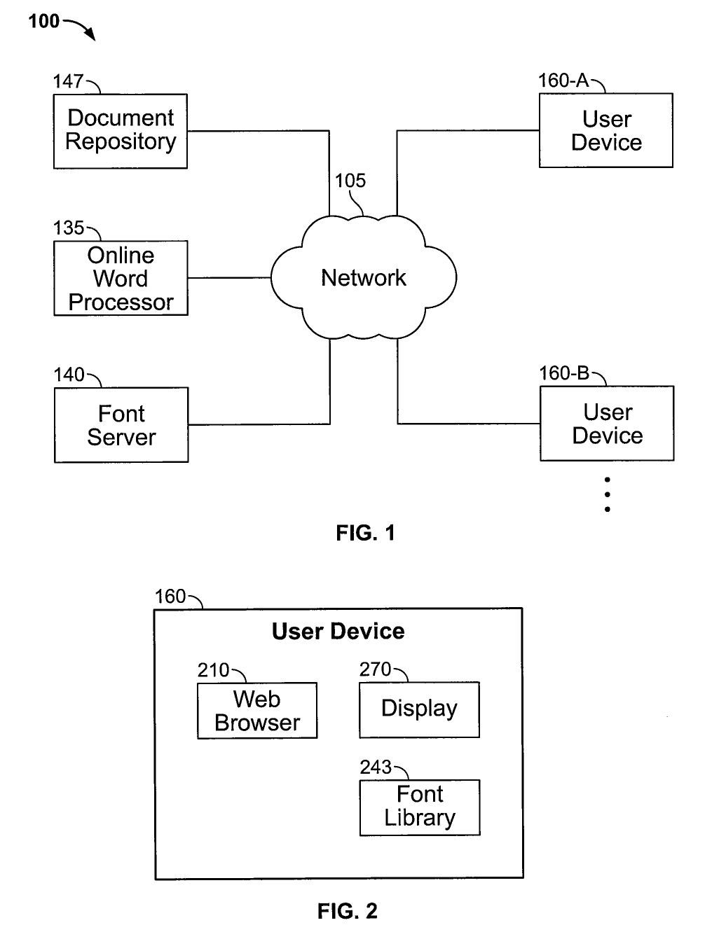

FIG. 1 shows a communication system 100 that may be used to provide online services, in accordance with an embodiment of the invention. Communication system 100 comprises a network 105, an online word processor 135, a font server 140, a document repository 147, and user devices 160-A, 160-B, etc. For convenience, the term “user device 160” is used herein to refer to any one of user devices 160-A, 160-B, etc. Accordingly, any discussion herein referring to “user device 160” is equally applicable to each of user devices 160-A, 160-B, etc. Communication system 100 may comprise more or fewer than two user devices.

In the exemplary embodiment of FIG. 1, network 105 is the Internet. In other embodiments, network 105 may comprise one or more of a number of different types of networks, such as, for example, an intranet, a local area network (LAN), a wide area network (WAN), a wireless network, a Fibre Channel-based storage area network (SAN), or Ethernet. Other networks may be used. Alternatively, network 105 may comprise a combination of different types of networks.

Online word processor 135 comprises a word processing application accessible to users via network 105. Online word processor 135 provides online word processing services, enabling users to create, display, and edit documents remotely. Online word processor 135 may be accessible via a World Wide Web page that may be viewed using a conventional Web browser, for example. A user may be required to log into a respective user account to access his or her documents. Online word processor 135 may offer common word processing features such as text searching, redlining, etc.

In accordance with an embodiment of the invention, online word processor 135 offers access to a plurality of fonts, and allows users to render a selected portion of a document in a desired font.

User-created documents may be stored in document repository 147. A document created by a user may be stored in association with his or her user account, for example.

Font server 140 stores information relating to various fonts used by online word processor 135. For example, font server 140 may store information defining the size and style of each font.

In other embodiments, any of the functions of online word processor 135, document repository 147 and/or font server 140 may be combined and performed by a single component. Alternatively, online word processor 135, document repository 147 and font server 140 may function separately but reside and operate on a single device.

User device 160 may be any device that enables a user to communicate via network 105. User device 160 may be connected to network 105 through a direct (wired) link, or wireles sly. User device 160 may have a display screen (not shown) for displaying information. For example, user device 160 may be a personal computer, a laptop computer, a workstation, a mainframe computer, etc. Alternatively, user device 160 may be a mobile communication device such as a cell phone, a Blackberry, a personal digital assistant, etc. Other devices may be used.

FIG. 2 shows functional components of user device 160, in accordance with the embodiment of FIG. 1. User device 160 comprises a web browser 210, a display 270, and a font library 243. Web browser 210 may be a conventional web browser used to access World Wide Web sites via the Internet, for example. Display 270 displays documents, Web pages, and other information to a user. For example, a document that a user is editing may be displayed on display 270. Font library 243 stores information pertaining to one or more fonts that may be used when the user creates, edits, or displays a document.

In accordance with the embodiment of FIG. 1, a user may access online word processor 135 in order to create and/or edit a document. For example, a user may employ browser 210 to access a World Wide Web site maintained by online word processor 135. In a well-known manner, the user may be required to log into a user account to access his or her documents. The user may be required to authenticate his or her identity, e.g., by entering a user name and password, before accessing his or her user account and any documents associated with the account.

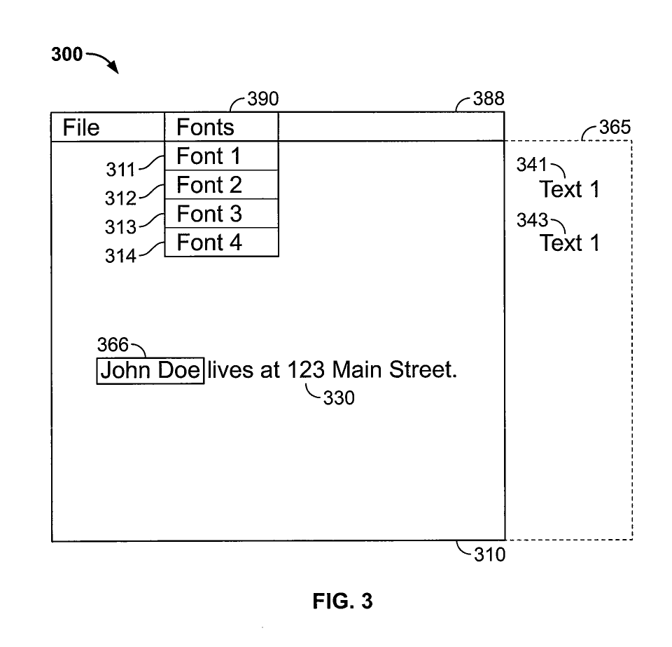

In accordance with an embodiment, a user employing user device 160 may access online word processor 135 and create a new document 300, shown in FIG. 3. Document 300 comprises text 330 which reads, “John Doe lives at 123 Main Street.” When the user saves document 300, the document is stored in document repository 147. In the example of FIG. 3, online word processor 135 causes user device 160 to display document 300 on a Web page, in a well-known manner. For example, online word processor 135 may transmit to user device 160 data in the form of HyperText Markup Language (HTML), adapted to cause user device 160 to display document 300.

Many user devices store a limited number of fonts in local storage. Fonts offered by online word processor 135 are stored in font server 140. In one embodiment, the number of fonts offered by online word processor 135 is greater than the number of fonts stored on user device 160. For example, font library 243 (shown in FIG. 2) may include about eight different fonts, and font server 140 may store twenty, or more, different fonts. Some commonly-used fonts may be stored both by user device 160 and by font server 140.

When a user of online word processor 135 selects, for use in a document, a font that is offered by online word processor 135 but is not stored locally on user device 160, online word processor 135 requests that user device 160 obtain the desired font from font server 140. Online word processor 135 may provide an address of font server 140 and/or an identifier associated with the font, for example. In response, browser 210 connects to font server 140 and requests the desired font. Font server 140 retrieves the requested font from memory and transmits the font to user device 160. User device 160 receives the new font and stores it in font library 243.

Online word processor 135 may provide a font to user device 160 using other methods. For example, online word processor 135 may retrieve a font from font server 140 and transmit the font directly to user device 160. Alternatively, information pertaining to various fonts may be stored in online word processor 135 and provided to user device 160 upon request.

After user device 160 has downloaded a desired font and stored it in memory, if a user of online word processor 135 selects the font for use in a document, by indicating a selected portion of text in a document and selecting the desired font from a menu, for example, online word processor 135 may transmit data adapted to cause user device 160 to display the text in the desired font. For example, online word processor 135 may request that user device 160 display the text in the desired font, in accordance with known communication protocols. Online word processor 135 may cause user device 160 to display text in a selected font using other methods.

It has been observed that when a user of an online word processing application selects, for use in a document, a font that is offered by the online word processing application but is not stored locally on the user's device, the user can undergo a potentially confusing experience when the selected font is downloaded by the user's device. In particular, the user device may continue to display the user's document in a default font after the user's selection of the desired font until the desired font has been downloaded by the user's device. When the download is complete, the document may be suddenly displayed in the desired font. Some users, not understanding that it sometimes necessary to download fonts, may be confused by such delays.

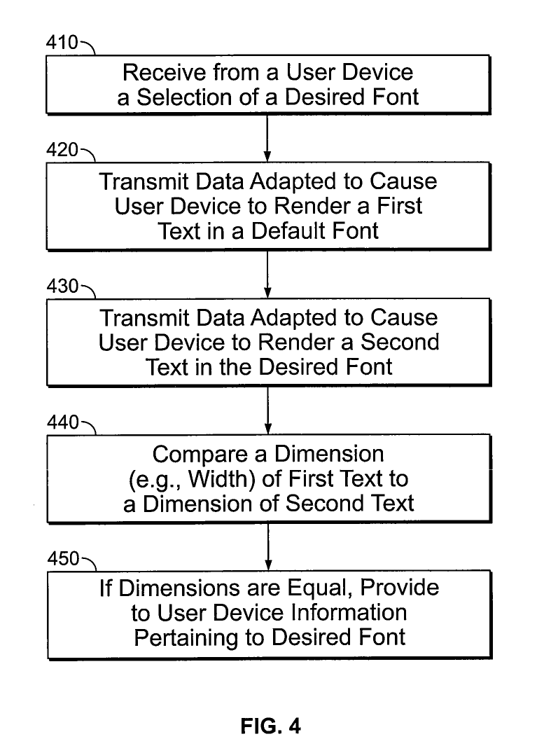

In accordance with an embodiment of the invention, a method for providing enhanced font management services is provided in which a requested font is provided in a user-friendly manner. FIG. 4 is a flowchart of a method for providing enhanced font management services, in accordance with an embodiment of the invention. FIG. 4 is described herein with reference to the following example.

Suppose that a user wishes to edit document 300, employs user device 160 to connect to online word processor 135, and accesses document 300 (shown in FIG. 3). Online word processor 135 retrieves document 300 from document repository 147 and causes user device 160 to display the document. Referring to FIG. 3, a portion 310 of document 300 is displayed on display 270. User device 160 also displays a toolbar 388, which includes options such as fonts option 390.

Suppose further that the text of document 300 is in a default font, FONT1, but that that the user wishes to change the font of the words “John Doe” (366) in document 300 from the default font to a second font, FONT2. The user accordingly highlights the words “John Doe” (366) and selects font option 390 available on toolbar 388, causing a dropdown menu to appear which includes four available font options, FONT1 (option 311), FONT2 (option 312), FONT3 (option 313), and FONT4 (option 314). More or fewer than four fonts may be available. The user selects FONT2 (option 312). User device 160 transmits the selection to online word processor 135. Referring to FIG. 4, the user's selection of the desired font is received by online word processor 135 from user device 160, at step 410.

Online word processor 135 determines whether or not it is necessary to provide the desired font (FONT2) to user device 160. To determine whether the desired font is already stored on user device 160, at step 420, online word processor 135 transmits data adapted to cause user device 160 to render a first text in the user device's default font (FONT1). In the example of FIG. 3, online word processor 135 transmits a request that user device 160 render a first text string 341, which includes the alphanumeric characters “Text1,” in the device's default font. In response, browser 210 renders first text string 341 in a region 365 that is not displayed to the user. For example, browser 210 may render text string 341 in a portion of a document object model (“DOM”) that is not displayed to the user.

At step 430, online word processor 135 transmits data adapted to cause user device 160 to render a second text in the desired font. In this example, online word processor 135 transmits a request that user device 160 render a second text string 343, which also including the alphanumeric characters “Text1,” in region 365 (which is not displayed to the user). Text strings 341 and 343 may be rendered in other regions or other locations.

At step 440, online word processor 135 transmits a request that user device 160 measure a dimension of first text string 341 and a dimension of second text string 343. In one embodiment, the width of the text 341 and the width of text 343 are measured. User device 160 informs online word processor 135 of the width measurements, and online word processor 135 compares the widths of the text strings. If the widths of the first and second text strings are different, online word processor 135 determines that user device 160 rendered text string 343 in the desired font and that user device 160 already has the desired font (FONT2) stored locally. Online word processor 135 therefore concludes that there is no need to provide FONT2 to user device 160.

If the widths of the first and second text strings are the same, online word processor 135 concludes that user device 160 does not have the desired font (FONT2) stored locally, and that user device 160 instead used the default font (FONT1) to render both text strings 341 and 343. Accordingly, online word processor 135 provides to user device 160 information pertaining to the desired font (FONT2), at step 450. Online word processor 135 may transmit a request that user device 160 download the desired font from font server 140 (or from another specified source), for example. The request may contain information concerning an address of server 140 and/or a storage location of the desired font, for example. User device 160 downloads the desired font and stores the font in font library 243.

In other embodiments, dimensions other than width may be used in performing the method described in FIG. 4. For example, a height of a first text may be compared to a height of a second text.

In another embodiment of the invention, when user device 160 connects to online word processor 135, online word processor 135 determines which fonts are available from font server 140 that are not stored in font library 243. Accordingly, when user device 160 connects to online word processor 135, for each respective font available from font server 140, online word processor 135 transmits a request that user device 160 render a first text in the user device's default font, and a request that user device 160 render a second text in the respective font. In response, user device 160 renders a first text in the default font and a second text in the respective font. The first and second texts may be rendered in a region that is not displayed, for example. Online word processor 135 further transmits a request that user device 160 measure a dimension of the first text and a dimension of the second text, in the manner described above. In one embodiment, the width of the first text and the width of the second text are measured. User device 160 informs online word processor 135 of the width measurements, and online word processor 135 compares the widths of the texts. If the widths of the first and second texts are different, online word processor 135 determines that user device 160 rendered the second text in the respective font and that user device 160 already has the respective font stored locally. If the widths of the first and second texts are the same, online word processor 135 concludes that user device 160 does not have the respective font stored locally, and that user device 160 instead used the default font to render both texts. Online word processor 135 may in such case provide to user device 160 information pertaining to the respective font (such as a location of the font on font server 140). In this manner, online word processor 135 and user device 160 determine which fonts available from font server 140 are not stored locally on user device 160. Subsequently, when a user requests a font that is not stored in font library 243 of user device 160, user device 160 may download the font from font server 140.

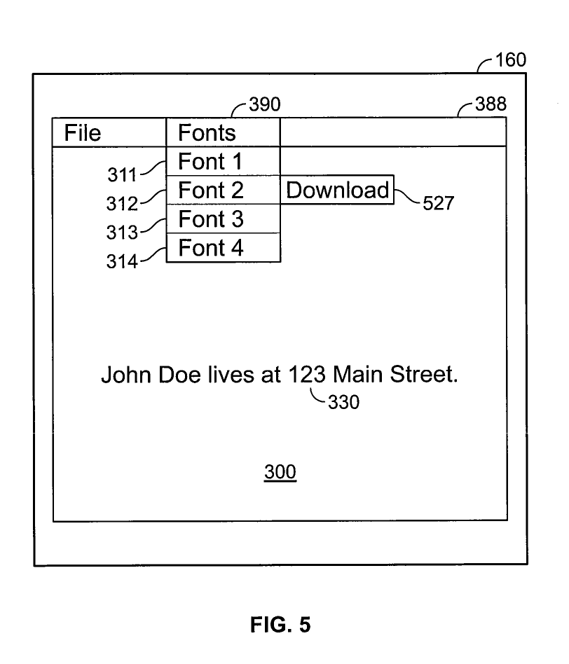

In another embodiment of the invention, a user requesting a desired font is provided an option to download the desired font. Referring to FIG. 5, when a user selects FONT option 390 from toolbar 388 and then selects option 312 (FONT2) from among the available fonts, online word processor 135 first determines whether or not user device 160 already has FONT2 stored locally, in the manner described above. If it is determined that user device 160 does not have FONT2 stored locally, online word processor 135 causes user device 160 to display a font download option 527. If the user wishes to download FONT2, the user may select download option 527. When online word processor 135 receives the user's selection of download option 527, online word processor 135 provides FONT2 to user device 160. Online word processor 135 may direct user device 160 to download the font from font server 140, for example.

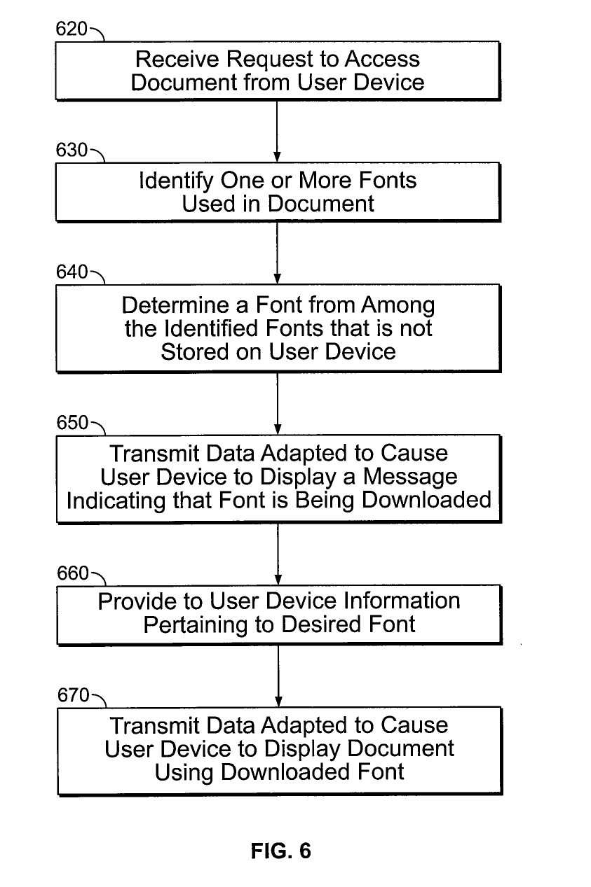

In accordance with another embodiment, while a font is being downloaded by user device 160, online word processor 135 causes user device 160 to display a message informing the user that the font is currently being downloaded. Displaying such a message can provide a more user-friendly experience to users of an online word processing application. FIG. 6 is a flowchart of a method for providing a font to a user device, in accordance with an embodiment of the invention.

Suppose that a user employing user device 160 connects to online word processor 135 and requests access to document 300. At step 620, online word processor 135 receives the request to access document 300 from user device 160. At step 630, online word processor 135 identifies one or more fonts used in document 300. Online word processor 135 determines whether each of the identified fonts is stored locally on user device 160. In this example, online word processor 135 determines that one of the fonts used in document 300 is not stored on the user device, at step 640.

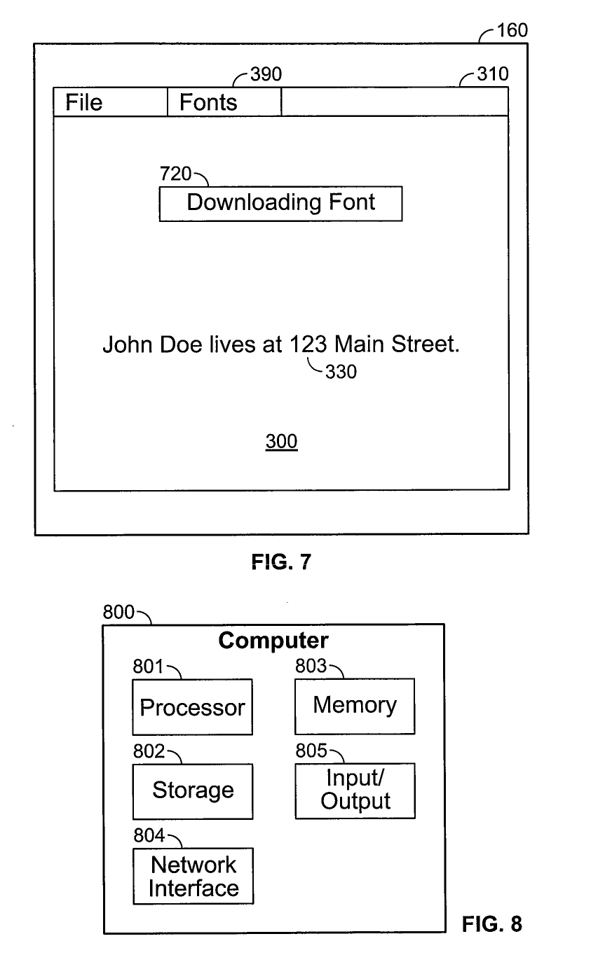

At step 650, online word processor 135 transmits data adapted to cause user device 160 to display a message indicating that the missing font is being downloaded. For example, online word processor 135 may transmit a request that user device 160 display a message indicating that the missing font is being downloaded. In response, user device 160 displays a downloading font message 720, as shown in FIG. 7. At step 660, online word processor 135 provides information pertaining to the missing font to user device 160. For example, online word processor 135 may transmit to user device 160 a request that user device 160 download the missing font from font server 140. The information pertaining to the missing font may also include an address of font server 140 and/or a storage location of the missing font, for example. In response, user device 160 downloads the missing font and stores the font in font library 243. Downloading message 720 is displayed until the download is complete.

At step 670, online word processor 135 transmits data adapted to cause user device 160 to display document 300 using the downloaded font. Online word processor 135 may transmit an appropriate request to user device 160, for example.

In accordance with another embodiment, a font may be provided to multiple user devices that are sharing a document. Suppose, for example, that a first user employing user device 160-A is sharing document 300 with a second user employing user device 160-B. When the first user connects to online word processor 135 and requests access to document 300, online word processor 135 identifies which fonts are used in document 300 and determines if any of the fonts are not currently stored in user device 160-A. If a font used in document 300 is not stored in user device 160-A, online word processor 135 provides information pertaining to the font to user device 160-A. Online word processor 135 may transmit a request that user device 160 download the font from font server 140, for example. Online word processor 135 may also transmit data adapted to cause user device 160-A to display a message indicating that the font is being downloaded, in the manner described above. Online word processor 135 also provides the font to user device 160-B (employed by the second user), and causes the user device 160-B to display a message indicating that the font is being downloaded.

In another embodiment of the invention, font libraries stored in multiple user devices employed by users sharing a particular document are synchronized. For example, while users employing user devices 160-A and 160-B are editing document 300, online word processor 135 may access font library 243 (of user device 160-A) to identify which fonts are stored therein, and similarly examine a font library of user device 160-B to determine which fonts are stored therein. Online word processor 135 may then copy to user device 160-A any fonts from user device 160-B that are not currently stored in user device 160-A, and copy to user device 160-B any fonts from user device 160-A that are not currently stored in user device 160-B. Online word processor 135 may perform such font synchronization as a background routine, for example.

In various embodiments, the method steps described herein, including the method steps described in FIGS. 4 and 6, may be performed in an order different from the particular order described or shown. In other embodiments, other steps may be provided, or steps may be eliminated, from the described methods.

Systems, apparatus, and methods described herein may be implemented using digital circuitry, or using one or more computers using well-known computer processors, memory units, storage devices, computer software, and other components. Typically, a computer includes a processor for executing instructions and one or more memories for storing instructions and data. A computer may also include, or be coupled to, one or more mass storage devices, such as one or more magnetic disks, internal hard disks and removable disks, magneto-optical disks, optical disks, etc.

Systems, apparatus, and methods described herein may be implemented using computers operating in a client-server relationship. Typically, in such a system, the client computers are located remotely from the server computer and interact via a network. The client-server relationship may be defined and controlled by computer programs running on the respective client and server computers.

Systems, apparatus, and methods described herein may be used within a network-based cloud computing system. In such a network-based cloud computing system, a server or another processor that is connected to a network communicates with one or more client computers via a network. A client computer may communicate with the server via a network browser application residing and operating on the client computer, for example. A client computer may store data on the server and access the data via the network. A client computer may transmit requests for data, or requests for online services, to the server via the network. The server may perform requested services and provide data to the client computer(s). The server may also transmit data adapted to cause a client computer to perform a specified function, e.g., to perform a calculation, to display specified data on a screen, etc. For example, the server may transmit a request adapted to cause a client computer to perform one or more of the method steps described herein, including one or more of the steps of FIG. 4 and/or 6. Certain steps of the methods described herein, including one or more of the steps of FIG. 4 and/or 6, may be performed by a server or by another processor in a network-based cloud-computing system. Certain steps of the methods described herein, including one or more of the steps of FIG. 4 and/or 6, may be performed by a client computer in a network-based cloud computing system. The steps of the methods described herein, including one or more of the steps of FIG. 4 and/or 6, may be performed by a server and/or by a client computer in a network-based cloud computing system, in any combination.

Systems, apparatus, and methods described herein may be implemented using a computer program product tangibly embodied in an information carrier, e.g., in a non-transitory machine-readable storage device, for execution by a programmable processor; and the method steps described herein, including one or more of the steps of FIG. 4 and/or 6, may be implemented using one or more computer programs that are executable by such a processor. A computer program is a set of computer program instructions that can be used, directly or indirectly, in a computer to perform a certain activity or bring about a certain result. A computer program can be written in any form of programming language, including compiled or interpreted languages, and it can be deployed in any form, including as a stand-alone program or as a module, component, subroutine, or other unit suitable for use in a computing environment.

A high-level block diagram of an exemplary computer that may be used to implement systems, apparatus and methods described herein is illustrated in FIG. 8. Computer 800 comprises a processor 801 operatively coupled to a data storage device 802 and a memory 803. Processor 801 controls the overall operation of computer 800 by executing computer program instructions that define such operations. The computer program instructions may be stored in data storage device 802, or other computer readable medium, and loaded into memory 803 when execution of the computer program instructions is desired. Thus, the method steps of FIG. 4 and/or 6 can be defined by the computer program instructions stored in memory 803 and/or data storage device 802 and controlled by processor 801 executing the computer program instructions. For example, the computer program instructions can be implemented as computer executable code programmed by one skilled in the art to perform an algorithm defined by the method steps of FIG. 4 and/or 6. Accordingly, by executing the computer program instructions, the processor 801 executes an algorithm defined by the method steps of FIG. 4 and/or 6. Computer 800 also includes one or more network interfaces 804 for communicating with other devices via a network. Computer 800 also includes one or more input/output devices 805 that enable user interaction with computer 800 (e.g., display, keyboard, mouse, speakers, buttons, etc.).

Processor 801 may include both general and special purpose microprocessors, and may be the sole processor or one of multiple processors of computer 800. Processor 801 may comprise one or more central processing units (CPUs), for example. Processor 801, data storage device 802, and/or memory 803 may include, be supplemented by, or incorporated in, one or more application-specific integrated circuits (ASICs) and/or one or more field programmable gate arrays (FPGAs).

Data storage device 802 and memory 803 each comprise a tangible non-transitory computer readable storage medium. Data storage device 802, and memory 803, may each include high-speed random access memory, such as dynamic random access memory (DRAM), static random access memory (SRAM), double data rate synchronous dynamic random access memory (DDR RAM), or other random access solid state memory devices, and may include non-volatile memory, such as one or more magnetic disk storage devices such as internal hard disks and removable disks, magneto-optical disk storage devices, optical disk storage devices, flash memory devices, semiconductor memory devices, such as erasable programmable read-only memory (EPROM), electrically erasable programmable read-only memory (EEPROM), compact disc read-only memory (CD-ROM), digital versatile disc read-only memory (DVD-ROM) disks, or other non-volatile solid state storage devices.

Input/output devices 805 may include peripherals, such as a printer, scanner, display screen, etc. For example, input/output devices 805 may include a display device such as a cathode ray tube (CRT) or liquid crystal display (LCD) monitor for displaying information to the user, a keyboard, and a pointing device such as a mouse or a trackball by which the user can provide input to computer 800.

Any or all of the systems and apparatus discussed herein, including online word processor 135, document repository 147, font server 140, and user device 160, and components thereof, including web browser 210, font library 243, and display 270, may be implemented using a computer such as computer 800.

One skilled in the art will recognize that an implementation of an actual computer or computer system may have other structures and may contain other components as well, and that FIG. 8 is a high level representation of some of the components of such a computer for illustrative purposes.

The foregoing Detailed Description is to be understood as being in every respect illustrative and exemplary, but not restrictive, and the scope of the invention disclosed herein is not to be determined from the Detailed Description, but rather from the claims as interpreted according to the full breadth permitted by the patent laws. It is to be understood that the embodiments shown and described herein are only illustrative of the principles of the present invention and that various modifications may be implemented by those skilled in the art without departing from the scope and spirit of the invention. Those skilled in the art could implement various other feature combinations without departing from the scope and spirit of the invention.

1. A method for providing online services, the method comprising:
transmitting a first request that the user device render a first text in a default font;
transmitting a second request that the user device render a second text in a desired font; and
providing data pertaining to the desired font to the user device, if a first dimension of the first text is the same as a second dimension of the second text.

2. The method of claim 1, further comprising:
transmitting a third request that the user device display a portion of a document; and
transmitting one or more requests that the user device render the first text and the second text in a region that is not displayed.

3. The method of claim 2, further comprising:
transmitting a fourth request that the user device display at least a portion of the document using the desired font.

4. The method of claim 1, wherein the first text and the second text comprise identical strings of alphanumeric characters.

5. The method of claim 1, wherein the online word processor is accessible via a network.

6. The method of claim 1, further comprising:
transmitting a third request that the user device display a message indicating that the desired font is being downloaded.

7. The method of claim 6, further comprising:
receiving from the user device a selection of an option to download the desired font.

8. The method of claim 1, wherein the first dimension is a width of the first text and the second dimension is a width of the second text.

9. The method of claim 8, further comprising:
comparing the width of the first text to the width of the second text.

10. The method of claim 1, wherein the step of providing data pertaining to the desired font to the user device further comprises:
transmitting a third request that the user device download the desired font from a specified source.

11. The method of claim 10, wherein the data pertaining to the desired font comprises a storage location of the desired font.

12. A method for providing online services, the method comprising:
receiving a first request to access a document from a user device;
identifying one or more fonts used in the document;
determining a missing font that is not stored on the user device from among the identified fonts;
providing data pertaining to the missing font to the user device; and
transmitting a second request that the user device display the document using the one or more fonts.

13. The method of claim 12, further comprising:
transmitting a third request that the user device display a message indicating that the missing font is being downloaded;

14. The method of claim 13, further comprising:
providing the data pertaining to the missing font to a second user device; and
transmitting a fourth request that the second user device display a second message indicating that the missing font is being downloaded.

15. The method of claim 12, wherein the step of determining a missing font from among the identified fonts that is not stored on the user device further comprises:
comparing a dimension of a first text rendered in the missing font to a dimension of a second text rendered in a second font.

16. The method of claim 15, wherein the dimension of the first text is a width of the first text and the dimension of the second text is a width of the second text.

17. The method of claim 12, wherein the step of providing data pertaining to the missing font to the user device further comprises:
transmitting a third request that the user device download the missing font from a specified source.

18. The method of claim 12, wherein the data pertaining to the missing font comprises a storage location of the missing font.

19. A method for providing online services, the method comprising:
identifying one or more fonts used in a document that is shared by a plurality of user devices;
determining a missing font that is not stored on a selected one of the user devices from among the identified fonts; and
providing data pertaining to the missing font to the selected user device and to at least one other user device in the plurality of user devices.

20. The method of claim 19, further comprising:
transmitting a first request that the selected user device display a first message indicating that the missing font is being downloaded; and
transmitting a second request that the at least one other user device display a second message indicating that the missing font is being downloaded.

21. A non-transitory computer readable medium having program instructions stored thereon, the instructions capable of execution by a processor and defining the steps of:
transmitting a first request that the user device render a first text in a default font;
transmitting a second request that the user device render a second text in a desired font; and
providing data pertaining to the desired font to the user device, if a first dimension of the first text is the same as a second dimension of the second text.

22. The non-transitory computer readable medium of claim 21, further comprising program instructions defining the steps of:
transmitting a third request that the user device display a portion of a document; and
transmitting one or more requests that the user device render the first text and the second text in a region that is not displayed.

23. The non-transitory computer readable medium of claim 22, further comprising program instructions defining the step of:
transmitting a third request that the user device display at least a portion of the document using the desired font.

24. The non-transitory computer readable medium of claim 21, wherein the first text and the second text comprise identical strings of alphanumeric characters.

25. The non-transitory computer readable medium of claim 21, wherein the first dimension is a width of the first text and the second dimension is a width of the second text.
